(19) United States
(12) Patent Application Publication
(10) Pub. No.: US 2014/0308423 A1
(43) Pub. Date: Oct. 16, 2014

(54) Method and Apparatus for Producing Frozen Foam Products

(71) Applicants: Nari R. Nayini, Burr Ridge, IL (US); Theodore H. Gasteyer, Naperville, IL (US); Gary D. Lang, Naperville, IL (US); Sameer H. Israni, Westmont, IL (US); Balazs Hunek, Western Springs, IL (US)

(72) Inventors: Nari R. Nayini, Burr Ridge, IL (US); Theodore H. Gasteyer, Naperville, IL (US); Gary D. Lang, Naperville, IL (US); Sameer H. Israni, Westmont, IL (US); Balazs Hunek, Western Springs, IL (US)

(21) Appl. No.: 14/315,086

(22) Filed: Jun. 25, 2014

Related U.S. Application Data
(63) Continuation of application No. 13/651,053, filed on Oct. 12, 2012.
(60) Provisional application No. 61/546,662, filed on Oct. 13, 2011.

(51) Int. Cl. A23G 9/46

(52) U.S. Cl. CPC A23G 9/46
USPC 426/565; 62/66; 62/340; 62/320

(57) ABSTRACT

Disclosed are methods and apparatus for forming frozen foam products, including edible products, using air or gases or gas mixtures having an average molecular weight larger than that of air, wherein the products contain bubbles having a reduced average size preferably in a narrow size range.

### PRIORITY STATEMENT

This application is a continuation of pending U.S. patent application Ser. No. 13/651,053 filed Oct. 12, 2012, which claims priority from U.S. provisional application Ser. No. 61/546,662 filed Oct. 13, 2011, the disclosure of which is hereby incorporated by reference.

### TECHNICAL FIELD

The present invention relates to foam products and, more particularly, to a method and system for improving the stability and sensory attributes of cold or frozen food foam products including ice creams and non-dairy foam products such as icings and toppings.

### BACKGROUND OF THE INVENTION

Commercially produced ice cream products are essentially an emulsion which forms a foam. FIG. 1 illustrates and outlines a standard process flow diagram for the current method of manufacturing frozen food foams such as ice creams. The ingredients (105) are first mixed together (110) and then pasteurized (115) to kill micro-organisms. The mix is then homogenized (120) by passing through high pressure valves in order to provide a more stable oil-in-water (o/w) emulsion. The homogenized mix is then mixed with the desired flavors and colors (125) and allowed to age, for instance at approximately 40 degrees Fahrenheit for a suitable time such as 4 to 8 hours. During the ageing process (130), multiple changes occur on the surface of the dispersed fat droplets contained within the homogenized mix and this prepares the mix for partial coalescence. Next, the mix is partially frozen, typically in a scraped surface freezer. Air (135) is normally introduced into the mix during this freezing process (140) or in some cases the air can be provided just prior to the freezer using various kinds of pre-aerators. Next, any inclusions and/or variegates (145) are added to the product. The product is then packaged (150) and finally hardened. Hardening (155) is a more complete freezing of the product and is typically carried out in mechanical blast freezers. For some products, like ice cream novelties, the hardening step may occur before the product is packaged.

The ice cream manufacturing steps generally include: mixing the liquid and dry ingredients; pasteurization and homogenization (in either order) followed by addition of flavors and colors. The product is then aged during the ageing step, after which, air is introduced. During the ageing step, the homogenized and pasteurized mixture is generally cooled down to about 35 degrees Fahrenheit to 40 degrees Fahrenheit and stored for at least 4 hours in tanks with minimum agitation. The main purpose of the ageing step is to promote fat destabilization. In other words, the ageing step provides time for the emulsifiers in the product to displace proteins from the fat globule surface which reduces the membrane thickness of the fat globule and makes it more susceptible to coalescence. Also, the ageing step provides time for partial fat crystallization, so that the fat globules can also partially coalesce. In general about 30 percent to about 50 percent of the fat crystallizes during the typical ageing step and the fat droplets partially coalesce yielding a fat droplet network.

After ageing, the foam product is next directed to a conventional scraped surface heat exchanger where the product is subjected to the freezing and aerating step. The air may be incorporated into the aged mix prior to the scraped surface heat exchanger, using a device such as a mechanical pre-aerator, or may be directly introduced into the scraped surface heat exchanger. The typical residency time of product within the scraped surface heat exchanger is normally between about 30 to 120 seconds. During this freezing and aerating step, the air bubbles are incorporated, broken into smaller bubbles, and distributed within the ice cream product while the product undergoes partial freezing (e.g. about 30 to 50 percent of the water in the ice cream is frozen). The ice cream product is also normally whipped or agitated to further promote fat destabilization. Upon exiting the scraped surface heat exchanger, the ice cream product exhibits a temperature of about 20 degrees Fahrenheit and a viscosity typically between about 1000 to 5000 centipoise.

Upon exiting the scraped surface heat exchanger, the foam product is subsequently packaged and then hardened in a spiral or tunnel freezer. The targeted final temperature of the ice cream product is about minus 20 degrees Fahrenheit resulting in freezing about 60 to 85 percent of the water in the ice cream product. The residence time in the hardening freezer very much depends on numerous parameters including the size of the ice cream packaging and “overrun”. The term “overrun”, is used to indicate how much air or other gas a particular ice cream contains. It is basically the ratio of the volume of the ice cream, less the volume of the liquid ice cream mix, divided by the volume of the liquid ice cream mix. So, if 50 percent of the volume of the ice cream is air, the overrun would be 100 percent.

In frozen foams such as ice creams, increasing the overrun results in a decrease in the percentage of other ingredients (e.g. milk fat, carbohydrates, stabilizers, etc.) which in turn results in cost savings. Of particular value in ice cream products is reduction of the milk fat ingredient which allows for improving the dietary and nutritional characteristics of the ice cream product. Typically one would limit the overrun due to regulatory based restrictions on overrun (e.g. maximum allowable overrun) or because the overrun adversely affects the sensory and physical properties of the foam product that may occur with too much of an increase in overrun.

During the hardening step, the mechanical freezers chill the outside of the ice cream surface with very cold air, and rely on the thermal conductivity of the ice cream to chill the rest of the ice cream. However, foams like ice cream are very poor thermal conductors. Due to this, the center of the ice cream takes a long time to chill during the hardening process. Thus, during a large part of the hardening process, the viscosity of most of the ice cream is low. Thus, typically, ice crystals and air bubbles in the ice cream product rise sharply in size during the packaging and hardening steps. The quantity and size of these bubbles greatly influence the physio-chemical properties of the final foam product. In particular, there is a significant increase in average bubble size and coalescence during the hardening step due to gas bubble disproportionation and coalescence.

The ingredients typically used in most commercially available ice cream products consists of: (i) milkfat; (ii) milk solids not fat (MSNF) such as proteins, casein, whey proteins, etc.; (iii) carbohydrates (e.g. lactose) and sweeteners, such as sucrose or corn syrup; (iv) water; (v) stabilizers and surfactants, including gelatins, gums, sodium alginate, carrageenan, etc., and surfactants; (vi) emulsifiers, such as mono-glycerides, di-glycerides, polysorbates, polyglycerins, and combinations thereof; and (vii) air or other gas bubbles.

In general, the milk fat typically represents about 10 to 16 weight percent of the liquid ice cream mix and provides flavor, texture and smoothness to the ice cream. A continuing challenge for ice cream manufacturers is to lower the milkfat content in the ice cream product while maintaining the sensory feel and taste of the ice cream.

The MSNF, and more particularly, the proteins within the MSNF, improve the texture of the ice cream (e.g., body and bite) and also help emulsify and whip the fats during manufacturing of the ice cream product. The carbohydrates, sweeteners, and any added flavorings are included to generally improve the taste of the ice cream, including sweetness, palatability, and texture. The carbohydrates also tend to aid in freezing point depression of the ice cream product which improves the scoopability of the ice cream product. The water represents about 55 to 64 weight percent of the liquid ice cream mix and provides the source of ice crystals in the ice cream product. If the ice crystal content is properly controlled this tends to also improve scoopability. The stabilizers and surfactants are used to add stability to the ice cream product during and after manufacture and possibly improve the sensory feel of the ice cream upon consumption. Finally, the emulsifiers are used primarily for fat destabilization through displacement of proteins on the surface of the fat droplets.

Typically, about 30 to 50 percent of the total ice cream volume is either air or another gas which functions to improve the taste (e.g. creaminess and texture desired by customers.

Stability of the final ice cream product is achieved by controlling the size and distribution of fat globules, ice crystals, and air bubble globules in the ice cream product. Optimized fat globule size and distribution is often achieved during the homogenization, ageing, and freezing steps in ice cream manufacture. During the ageing and freezing of the ice cream mix, the fat droplets partially coalesce to form a structural network within the liquid ice cream mix and this network of fat droplets coats the surface of the introduced air bubbles to provide stability (See FIG. 2). FIG. 2 depicts an enlarged view illustrating the key constituents of the micro-structure of a typical food foam product (during processing). The gas bubbles (210) and ice crystals (220) are generally well dispersed throughout the continuous phase of the unfrozen liquid phase (240). During the manufacturing process the fat droplets undergo partial coalescence yielding a 3-dimensional network that provides a support structure for the product. This network of partially coalesced fat droplets (230) tends to stick to the surface of the gas bubbles due to their hydrophobic nature and therefore contribute to the stability of the bubbles. The lower the level of fat, the lower the resultant gas bubble stability of the product. During the initial stages of hardening, the microstructure is most susceptible to change. This is mainly due to the low viscosity of the continuous phase which allows for bubble and ice crystal growth and channeling. Once hardened, the rate of change is extremely slow.

Ideally, an ice cream manufacturer would seek to develop an ice cream product with the smallest size and most uniform distribution of air or gas bubbles and ice crystals and retain this uniform dispersion of air or gas bubbles and ice crystals both during and after manufacture.

One manifestation of the stability problem in many foam products such as ice cream as well as whipped cream, icing or topping) is commonly referred to as the “altitude problem”. The altitude problem is defined as the degradation in the quality and stability of foam products during transportation or storage, due to pressure variations resulting from altitude changes occurring en-route. For example, when foam products are transported from a low altitude location to a high altitude location the ambient pressure proximate the foam product decreases. This change in ambient pressure causes the gas in the foam product to expand, which in turn adversely impacts the stability of the foam structure. In many cases, this gas expansion in the foam product results in coalescence of the individual gas bubbles and ultimately leads to a channeling effect and escape of the gas from the foam product. Because the trapped air or gas bubbles forth a significant portion of the total foam product volume, any change in volume of trapped air or gas bubbles due to pressure variations may lead to product damage, leakage and, in some cases, container deformation during shipping of the foam product to higher altitudes. On the other hand, when the expanded foam products are transported from the high altitude location to a lower altitude location, the ambient pressure proximate the foam product increases causing contraction of the foam, which causes the product to appear to have shrunk.

There is therefore, a continuing need in the industry for a method to improve the stability, homogeneity, and quality of ice creams and other food foams. In particular, there is a need to reduce or mitigate the stability problems associated with altitude in many ice creams and other food foams such as whipped products, icings and toppings as well as refrigerated, partially or fully frozen forms of the same.

### BRIEF SUMMARY OF THE INVENTION

One aspect of the present invention is a method for forming a frozen foam product comprising the steps of:

(A) introducing a selected gas or gas mixture which is air or is a gas or gas mixture which possesses a larger average molecular weight than air, into a product to be foamed under selected foaming conditions to form a foam product containing bubbles of said gas or gas mixture,

(B) in a selected relationship of being concurrent with or subsequent to step (A), chilling said foam product under selected chilling conditions to form a partially frozen foam product; and then

(C) increasing the viscosity of said partially frozen foam product by rapidly chilling it, thereby forming a further frozen foam product, and then

(D) hardening the further frozen food product by further chilling it under selected further chilling conditions to freeze additional liquid therein, so that the temperature of the product is 0 degrees Fahrenheit or lower, thereby funning a frozen foamed food product,

under conditions effective to establish bubbles in said frozen foamed food product having an average bubble size at least 15% smaller than the average bubble size in the hardened product that is formed by introducing solely air as the gas or gas mixture into the identical product to be foamed under the identical selected foaming conditions as in step (A) to form an air foamed product and chilling said air foamed product in the same selected relationship to step (A) and under the identical selected chilling conditions as in step (B) to form a product which is then hardened under the identical selected further chilling conditions as in step (D).

Another aspect of the invention is a method for forming a foamed food product comprising the steps of:

(A) introducing a selected gas or gas mixture which is air or is a gas or gas mixture which possesses a larger average molecular weight than air, into a product to be foamed under selected foaming conditions to form a foam product containing bubbles of said gas or gas mixture, and then

(B) increasing the viscosity of said foam product by rapidly chilling it, thereby forming a further frozen foam product, and then

(C) hardening the further frozen food product by further chilling it under selected further chilling conditions to freeze additional liquid therein, so that the temperature of the product is 0 degrees Fahrenheit or lower, thereby forming a frozen foamed food product,

under conditions effective to establish bubbles in said frozen foamed food product having an average bubble size at least 15% smaller than the average bubble size in the hardened product that is formed by introducing solely air as the gas or gas mixture into the identical product to be foamed under the identical selected foaming conditions as in step (A) to form an air foamed product which is then hardened under the identical selected further chilling conditions as in step (D).

In the aforementioned methods, the gas or gas mixture preferably comprises one or more of argon, xenon, and/or krypton, but the advantages of this invention properly applied are available using air to form the foam product.

In the aforementioned methods, the viscosity increasing preferably includes chilling the product from within.

Other, preferred, aspects of the present invention include

forming into a plurality of bits a portion of a foam product that is produced by (i) introducing a gas or gas mixture into a product to be foamed, in a manner which forms bubbles in said product, thereby forming a foam product, and (ii) concurrently with or subsequent to step (i), chilling said foam product while retaining said bubbles therein, wherein said bits have a temperature lower than minus 50 degrees Fahrenheit and lower than the temperature of the product whose viscosity is increased in the viscosity increasing step of either of the aforementioned methods, and adding said bits to said foam product in the viscosity increasing step.

Another aspect of the present invention is a system comprising

(A) a source of a product to be foamed, which product contains liquid;

(B) a source of air or of a gas or gas mixture which possesses a larger average molecular weight than air;

(C) foaming apparatus, connected to said source of a product to be foamed and connected to said source of said gas or gas mixture, which is capable of introducing said gas or gas mixture into said product to be foamed, in a manner which forms bubbles of said gas or gas mixture in said product, thereby forming a foam product;

(D) second apparatus, connected to said foaming apparatus to receive therefrom said foam product, which is capable of chilling or partially freezing said foam product while retaining said bubbles therein, to form a partially frozen foam product; and

(E) viscosity increasing apparatus, connected to said second apparatus to receive therefrom said partially frozen foam product, which is capable of increasing the viscosity of said partially frozen foam product by rapidly chilling it. Preferably the viscosity increasing apparatus includes apparatus capable of chilling the product from within, such as bit-forming apparatus capable of forming bits having the composition of said foam product and having a temperature less than minus 50 degrees Fahrenheit, wherein the bit-forming apparatus is connected to the viscosity increasing apparatus to feed said bits into said partially frozen foam product in said viscosity increasing apparatus.

Additional, preferred, aspects of the present invention include apparatus useful for creating super-cooled bits comprising

an extruder with an exit section,

a cutting device connected to said exit section of said extruder for cutting product extruded from said exit section into bits,

a vessel located proximate said exit section to receive bits cut by said cutting device in said vessel,

a source of liquid cryogen coupled to said vessel to controllably feed said liquid cryogen into said vessel, and a conveyor capable of carrying bits out of liquid cryogen in said vessel; and apparatus wherein

the aforementioned system including this apparatus is operatively included in the viscosity increasing apparatus of said system.

Yet other embodiments of the present invention include:

(I) a method for improving the stability and quality of a frozen foam product comprising the steps of: mixing ingredients to form a dispersed phase of the product;

introducing a gas or gas mixture into the dispersed phase of the product using a high shear mixing device, pre-aerator, supersonic diffuser, subsonic diffuser or stripping device to produce gas bubbles in the product that have an average bubble diameter of about 20 microns or less and a narrow bubble size distribution;

aerating the product with the gas or gas mixture to produce a foam product and concurrently or sequentially chilling and/or freezing the foam product to produce ice crystals in the foam product;

adjusting the viscosity of the foam product by cryogenically chilling or freezing some or all of the foam product before or during a packaging step;

packaging the foam product; and

hardening the packaged foam product into a frozen foam product;

wherein the gas bubbles within the hardened frozen foam product retain an average bubble diameter of about 20 microns or less and the narrow bubble size distribution,

(II) an improvement to the process of manufacturing frozen foam products to enhance the stability and quality of a frozen foam product, the improvement comprising:

introducing a low diffusivity gas or gas mixture into the foam product to produce gas bubbles in the product that have an average bubble diameter of about 20 microns or less and a narrow bubble size distribution; and

cryogenically chilling or freezing some or all of the foam product before or during a packaging step;

wherein the gas or gas mixture comprises argon, krypton or xenon and has a diffusivity in water of at least 10% lower than the diffusivity of nitrogen gas in water; and

wherein the gas bubbles within the frozen foam product retain an average bubble diameter of about 20 microns or less and the narrow bubble size distribution during packaging, hardening, transportation and storage; and

(III) an improvement to a frozen foam production system comprising:

a source of low diffusivity gas or gas mixture wherein the gas or gas mixture comprises argon, krypton or xenon and has a diffusivity in water of at least 10% lower than the diffusivity of nitrogen gas in water;

a high shear mixing device, pre-aerator, supersonic diffuser, subsonic diffuser or stripping device to mix the gas or gas mixture with the foam product and produce gas bubbles in the foam product that have an average bubble diameter of about 20 microns or less and a narrow bubble size distribution; and

a cryogenic chilling or freezing apparatus for cryogenically chilling or freezing some or all of the foam product before or during packaging of the foam product;

wherein the gas bubbles within the frozen foam product retain an average bubble diameter of about 20 microns or less and the narrow bubble size distribution during packaging and hardening steps.

As used herein, “average bubble size” is the average of gas bubble equivalent diameters in a product determined as follows: Gas bubbles are analyzed using a light microscope (40× magnification) housed in an insulated chamber that can be controlled at a desired temperature. The product to be analyzed is initially equilibrated in the chamber to minus 15 degrees Celsius. A slice of the product is then taken from the middle of the mass of the product, the top layer of the slice is removed and discarded, and the remainder of the slice is transferred to a microscope slide which has also been equilibrated to minus 15 degrees Celsius. The slice thickness is 100 to 200 microns to provide a uniform flat plane for observation. For gas bubble analysis the temperature of the slice is then raised to minus 6 degrees Celsius for image acquisition. Photographs of the slice including gas bubbles present therein are obtained by optical light microscopy at 40× magnification. The outline of the gas bubbles are traced and analyzed for equivalent diameter. For each sample, the equivalent diameters of a minimum of 300 to a maximum of 350 gas bubbles are measured. The average of the equivalent diameters of all bubbles that are measured is determined to be the average gas bubble size of the foam product.

As used herein, “chilling from within” means adding into a product one or more objects whose temperature is lower than the temperature of the product into which the objects are added, so that the one or more objects directly contact the product, wherein the temperature of the product including the temperature in the interior of the product is lowered by direct heat transfer from the product to the one or more objects. Preferably, the objects become part of the product, either as articles that can be observed in the product, or by their mass becoming fully incorporated into the mass of the product so as not to be separately observable.

### BRIEF DESCRIPTION OF THE DRAWINGS

The above and other aspeas, features, and advantages of the present invention will be more apparent from the following drawings, wherein:

FIG. 1 is a schematic depiction of a prior art process of ice cream manufacturing;

FIG. 2 is an illustration of the microstructure of a frozen foam ice cream product;

FIGS. 3a and 3b are schematic process flowsheets including embodiments of the present invention;

FIG. 4 is a cross-sectional schematic view of a pre-aerator suitable for creating and introducing small bubbles of a gas or gas mixture into a foam product and useful in practicing the present invention;

FIG. 5a is a process flow diagram depicting the process for forming and introducing super-cooled frozen bits into an ice cream product for rapidly chilling and/or freezing of the ice cream in accordance with an embodiment of the present invention.

FIG. 5b is an illustration of apparatus useful for making frozen bits that can be used for adjusting the viscosity of a foam product in accordance with the present invention;

FIG. 6 is an illustration of another apparatus useful for making frozen bits that can be used for adjusting the viscosity of a foam product in accordance with the present invention;

FIG. 7 is an illustration of an embodiment for adjusting the viscosity of a foam product in accordance with the present invention;

FIG. 8 is an illustration of another embodiment for chilling a foam product in accordance with the present invention;

FIG. 9 is a plot that shows the theoretically obtained results of the effect of gas bubble size on the volume change in a foam product due to altitude changes; and

FIG. 10 provides the melting profiles for e control and various treatments of the present invention for ice creams.

### DETAILED DESCRIPTION OF THE INVENTION

The present invention is useful in the production of frozen products having gas dispersed therein. Preferred products formed in accordance with this invention are edible products, such as ice cream, ice milk, sherbets, sorbets, whipped creams, toppings and frostings.

The present invention forms a foam starting from a product that is to be foamed. The product that is to be foamed can be provided by mixing together the desired ingredients in the desired amounts, or it can be provided by obtaining it from any suitable source where it has already been produced by combining the desired ingredients such that the operator does not need to combine ingredients to provide the product that is to be foamed. For example, an ice cream manufacturer may combine the desired ingredients to form a premix that is to be foamed, or the manufacturer may obtain from an independent source an ice cream premix in which the desired ingredients have already been combined.

The product to be foamed will include solids, namely the solid components of the desired final product, and a liquid component, which may itself be one substance or a mixture of liquid substances. The liquid may have one or more solutes dissolved in it. The most typical liquid is water. Other liquids may be present in addition to water, or instead of water, such as oils and/or alcohols. The product to be foamed in accordance with the present invention may contain 1 wt. % to 99 wt. % liquid, preferably 30 wt. % to 95 wt. % liquid.

The present invention may be characterized as a combination of some or all of the following features, including: use of air, or preferably of low diffusivity gas such as argon, krypton or xenon, or gas mixtures thereof, as described in more detail below, preferably having a larger average molecular weight than that of air (the gas or gas mixture may also be characterized as having a diffusivity in water at 25 degrees Celsius at least 10% lower than the diffusivity of nitrogen gas in water at 25 degrees Celsius); maintaining in the product of the invention small gas babbles which are at least 15% smaller in size than the bubbles produced by foaming the same product with air by the same procedure but without the viscosity increasing step described herein; preferably, providing in the final product a majority of bubbles having diameters of about 20 microns or less, preferably about 10 microns or less, with a narrow bubble size distribution; gas mixing using high shear mixing device, pre-aerators, supersonic diffuser, subsonic diffuser or stripping devices; and rapidly increasing the viscosity of the frozen foam product via rapid cryogenic chilling or freezing before and/or during packaging to prevent disproportionation of the small gas bubbles within the frozen foam product.

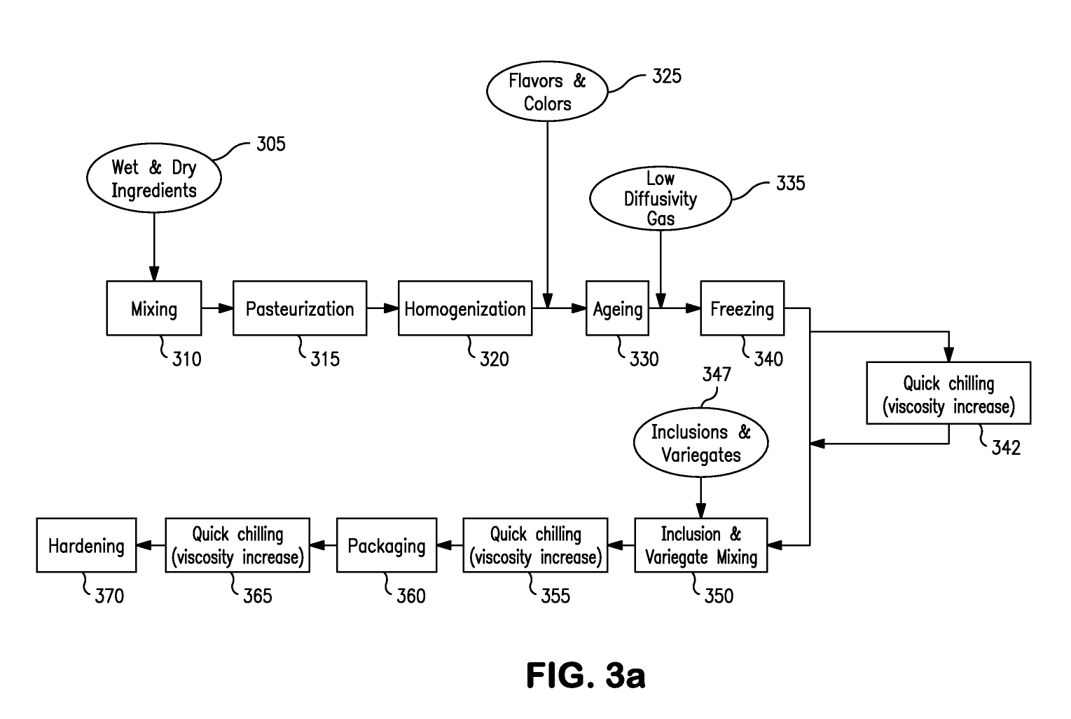

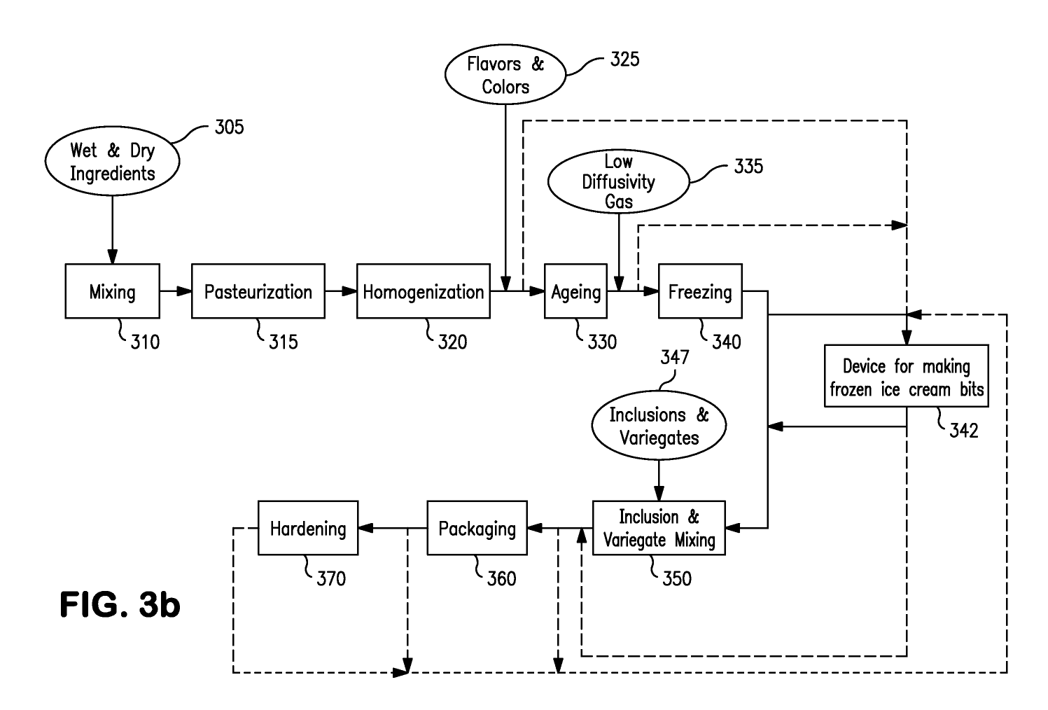

FIGS. 3a and 3b show an overall process for the manufacture of frozen foams, such as ice cream, including the present invention.

If the product to be foamed has not already been prepared, then it is prepared by mixing the ingredients (305) in step (310). The product can then be pasteurized in stage (315) to kill micro-organisms. The product can then be homogenized in stage (320) by passing through high pressure valves, in order to provide a more stable oil-in-water (o/w) emulsion, if the components of the product justify such treatment. If the product to be foamed has already been prepared, then stage (310) is avoided and the product is submitted directly to stages (315) and (320) as desired. The product is then mixed if desired with desired flavors and colors (325) and can be allowed to age in stage (330), for example at approximately 40 degrees Fahrenheit for a suitable length of time such as 4 to 8 hours, in the case of products such as ice cream, during the ageing stage, multiple changes occur on the surface of the dispersed fat droplets contained within the homogenized composition and this prepares the product for partial coalescence.

Stage (340) denotes the introduction of a gas or gas mixture (335) into the product, and the formation of a partially frozen foam product. Stages (345) (FIGS. 3a) and (342) (FIG. 3b) denote the step of increasing the viscosity of the partially frozen foam product. These stages are described below in more detail.

Inclusions and variegates (347) are optionally added to the product in stage (350). The product can then be packaged (stage (360)) and can be subjected to hardening (stage (370)). Stages (355) and (365) denote optional viscosity increasing stages each of which can be in addition to, or in lieu of, stage (345).

### The Gas or Gas Mixture

As seen in FIG. 3a, stage (335) denotes the introduction of a gas or gas mixture into the product to be foamed. This gas or gas mixture preferably comprises one or more of argon, krypton or xenon, or mixtures thereof, or mixtures of any of the foregoing with other gases or gas mixtures (such as air), where the gas or gas mixture can also contain nitrogen. The gas or gas mixture used can be air, or it can be a gas or gas mixture which has an average molecular weight greater than that of air. The “average molecular weight” is determined by the well-known technique of averaging the molecular weight of each component (wherein each component's molecular weight is as established in published sources) over the relative amounts of each component present in the gas mixture. The gas or gas mixture is also referred to herein as a low diffusivity gas. The ratio of the amount of gas or gas mixture introduced into the product to be foamed, to the amount of product into which the gas or gas mixture is introduced, is preferably 0.05:1 to 7.5:1, by volume. The use of the lower diffusivity gas significantly reduces the level of disproportionation of the gas bubbles in the foam, both prior to, during and after the hardening process. The reduced level of disproportionation results in smaller average gas bubble sizes and a narrower distribution of the bubble sizes.

Where the desired end product is intended to be edible, the gas or gas mixture is preferably nontoxic, by which is meant that contact with the gas in the course of producing the foam product, or ingestion of the gas or gas product in the course of consuming the foam product, does not cause death or illness to a person who contacts it or ingests it. Gases such as argon, xenon, krypton, and nitrogen are thus to be considered nontoxic.

### Forming a Partially Frozen Foam Product

The product is treated in stage (340) to partially freeze it, typically in a scraped surface freezer or other functionally equivalent heat exchanger. This stage is preferred but is optional in that some products, such as non-dairy whipped toppings, can be produced without, the need for this stage.

When stage (340) is included, the gas or gas mixture can be introduced into the product prior to, during, or both prior to and during this partial freezing stage. The gas or gas mixture is introduced into the product to be foamed in any of the many known techniques for feeding gas into such a product. The product is then subjected to a partial freezing step where the partially frozen foam product is formed using preferably a conventional scraped surface heat exchanger. The main objective of this freezing and “aerating” or gassing step and of the scraped surface heat exchanger is to: (i) aspirate the dispersed foam product by incorporating and comminuting the gas bubbles within the foam product; (ii) partially freeze the foam product by generating a plurality of ice crystal nuclei within the foam product; and (iii) further whip the foam product to further promote fat destabilization. This gas or gas mixture can either be incorporated directly into the product in the scraped surface heat exchanger, or prior to the scraped surface heat exchanger using one or more of high shear mixing devices, pre-aerators, supersonic, or subsonic diffusers, spargers, and/or stripping devices. Preferably, the partially frozen foam product contains small gas bubbles and exhibits a narrow gas bubble size distribution, whether the bubble sizes have been achieved upon feeding of the gas or gas mixture or by the manner in which the product is treated after the gas or gas mixture is fed. Thus, in some embodiments the bubbles that are initially formed are larger than are desired in the final product.

The typical residence time of product within the scraped surface heat exchanger is normally between about 30 to 120 seconds. During this freezing and aerating step, the bubbles of the gas or gas mixture are incorporated, broken into smaller bubbles, and distributed within the product while the product undergoes partial freezing (e.g. about 30 to 50 percent of the liquid in the product is frozen). The product is also normally whipped or agitated to further promote fat destabilization. Upon exiting the scraped surface heat exchanger, the product typically exhibits a temperature of about 20 degrees Fahrenheit and a viscosity typically between about 1000 to 5000 centipoise. The product formed in this stage is partially frozen, by which is meant that it contains ice crystals but is soft, pliable and deformable. Typically up to 50 wt. %, and generally 20 wt. % to 50 wt. %, of the liquid present in the product is frozen.

It is preferable that the average gas bubble diameter formed in the product is on the order of about 20 microns or less, preferably about 10 microns or less, and with a narrow bubble size distribution. A preferred example of narrow bubble size distribution is that about 80% or more of gas bubbles have a bubble size diameter in the 3 micron to 30 micron range.

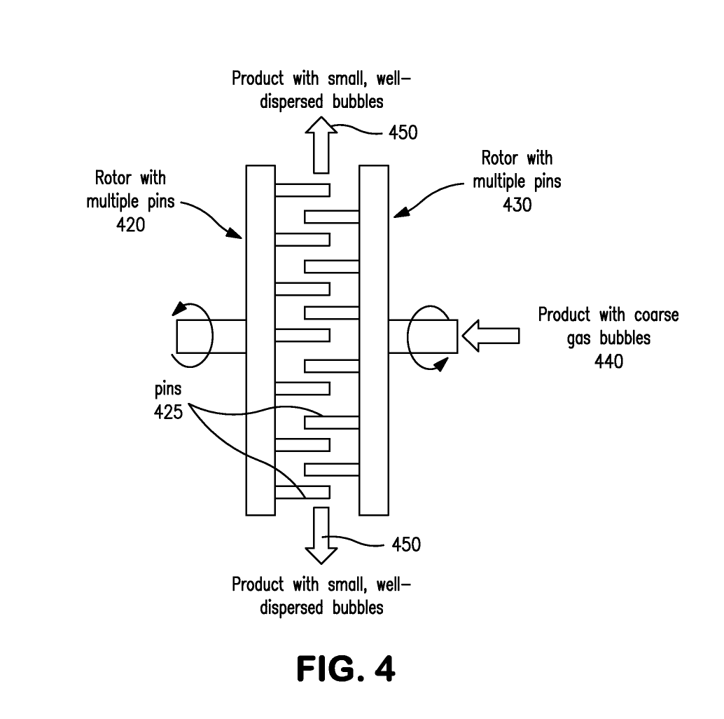

A preferred device to generate and introduce the small gas bubbles into the product to be foamed is a pre-aerator, as shown in FIG. 4.

FIG. 4 is a schematic view showing the basic concepts associated with the device. The device includes two discs (420, 430) rotating close to each other in opposite directions. Alternatively, one disc could be rotating while the other is held stationary. The product with entrained coarse gas bubbles (440), previously formed by the gas or gas mixture having already been fed into the product, flows between these two discs and experiences very high shear rates that cause breakdown of the bubbles. The discs can have pins (425), as seen in FIG. 4, that further decrease the gap between the discs, therefore increasing the shear. The device thus forms fine, well-dispersed gas bubbles in the foam product (450). In ice cream manufacture, the whipping machines utilize pre-aerators to incorporate the gas before the foam enters the scraped surface freezer. The use of pre-aerators has been known to decrease the average gas bubble size in the frozen product, thereby increasing its quality. Other devices operating on the Venturi principle can also be used as pre-aerators. This technology preferably employs pre-aerators that can provide small, well-dispersed gas bubbles in the product that is to be foamed. The use of low diffusivity gas and quick chilling and freezing steps greatly reduces the growth of these gas bubbles and the ice crystals in the foam product.

### Rapid Chilling/Freezing

The size and thus the properties of the gas bubbles in a frozen foam product, such as ice cream, can be further improved by minimizing disproportionation and coalescence of the gas bubbles during manufacturing of the foam product by increasing the viscosity of the product before a hardening step, and more preferably before and/or during a packaging step. Preferably, the viscosity of the partially frozen foam product is increased by rapidly chilling/freezing a portion of the product (preferably by use of cryogens) upstream of the packaging step, and then recombining the chilled or frozen portion with the remainder of the product, or by rapidly chilling the product directly by in-situ injection of cryogens as the product is being packaged. Rapid chilling/freezing can also be provided by direct or indirect heat transfer contact of the product with cryogen in the preaerator, in the partial freezing stage, and/or before, during or after the addition of inclusions to the product. The partially frozen foam product from stage (340) is treated to increase its viscosity by chilling or freezing some or all of the foam product. This quick chilling/freezing step can he carried out in one stage such as stage (345) or in two or more stages as indicated by stages (355) and (365). The quick chilling or freezing step rapidly increases the viscosity of the continuous phase of the foam product. This increase in viscosity further decreases the diffusivity of the gas through the continuous phase. The increase in viscosity also reduces the tendency of adjacent gas bubbles to coalesce. The increased viscosity also reduces the increase of ice crystal sizes. The end result is a foam product that has significantly lower average gas bubble sizes and number as well as lower ice crystal sizes, compared to products made by prior art techniques.

Overall, in the viscosity increasing step, the partially frozen foam product is preferably chilled at a rate such that liquid that is present is frozen to solid at a rate of at least 5 wt. % of the liquid in 5 minutes or less, preferably in 3 minutes or less and more preferably in 1 minute or less, where the 5 wt. % is based on the amount of liquid that is present in the product at the end of step (A), i.e. the introduction of the gas or gas mixture (this can be at the beginning of the chilling step where there is a chilling step, otherwise at the beginning of the viscosity increasing step). For example, where the liquid present is water, water ice is formed in the product in this step at a rate that is equivalent to freezing of an amount of water that is at least 5 wt. % of the amount of liquid water present at the end of step (A), in 5 minutes or less. By “frozen to solid” is meant that the liquid is frozen to a plurality of crystals of the solid state, or (less preferably) is frozen to one unitary solid.

The viscosity increasing step can be carried out by exposing an exterior surface of the product (whether or not in a package) to temperature conditions colder than the temperature of the product. This practice is especially useful where the mass of individual units of product is relatively small, such as individual portions of ice cream. Examples of this practice include placing the product in or through a chiller or freezer, in which the atmosphere within the chiller or freezer is colder than the temperature of the product, or contacting an exterior surface of the product with a colder gas, gas mixture or liquefied gas. It is preferred to achieve some or all of the viscosity increasing by chilling the product from within the product, such as in a manner as described herein, especially when the mass of the product is relatively large.

FIG. 3b shows an embodiment of the rapid chilling or freezing technique. The partially frozen foam product stream from stage (340) (such as exiting a scraped surface freezer or other functionally equivalent heat exchanger) is split into two streams, a main stream and a secondary stream. Alternatively, the product stream splitting is performed at other stages, for example, after the homogenization (320) stage or after the ageing (330) stage or after the addition of inclusions and variegates (350) or after packaging (360) or after hardening (370). The main stream is preferably 75 percent or more of the full product stream, and more preferably about 90 percent of the full product stream. The main stream is routed directly from stage (340) to the packaging step (360) after optional addition of inclusions and variegates (347) in stage (350).

The secondary stream of the ice cream product is preferably 25 percent or less of the full product stream, and more preferably about 10 percent of the full product stream. The secondary stream is diverted to a stage (342) where it is rapidly chilled, preferably at a rate of at least 20 degrees Fahrenheit per minute and more preferably at least 30 degrees Fahrenheit per minute. A particularly advantageous embodiment is to form the secondary stream into super-cooled or deep frozen discrete product bits or pieces. The frozen bits are then uniformly distributed into the main product stream prior to or during the packaging step. This mixing of super-cooled bits causes a rapid drop in temperature of the main stream and therefore a rapid increase in its viscosity. This embodiment is a preferred mode of providing rapid chilling of the product from within the product. This method of rapidly increasing the viscosity is insensitive to packaging size and less sensitive to thermal conductivity of the product than current conventional processes.

The super-cooled bits, or any other products which are added to the product so as to provide chilling from within the product, are preferably added to the product throughout the interior of the mass of the product, and more preferably uniformly throughout the interior of the mass of the product.

Alternate embodiments of the rapid cryogenic chilling aspect of the present system and method are performed by following the dashed lines in FIG. 3b. In particular, the secondary stream of product may be diverted to the cryogenic chiller or freezer prior to the step of gas mixing or immediately after the step of gas mixing. Still further embodiments include the diversion of pre-packaged stream, packaged stream, the hardened product stream or combinations of any of the above-identified diverted streams to the cryogenic chiller or freezer. Yet a further embodiment of the present system and method includes rapid cryogenic freezing or chilling of the inclusions (e.g. fruit, chocolate chips) or variegates (e.g. syrup) and incorporating the cryogenically chilled or frozen inclusions or variegates into the ice cream stream prior to or during the packaging step. In this manner, the viscosity of the recombined foam product prior to packaging and hardening is further increased. By adding the deep frozen product bits and uniformly dispersing the super-cooled or frozen product bits within the main stream, the recombined product stream is further chilled. This partial freezing of the recombined product stream rapidly increases the product viscosity during processing and significantly reduces gas bubble coalescence and disproportionation during the packaging and hardening of the foam product.

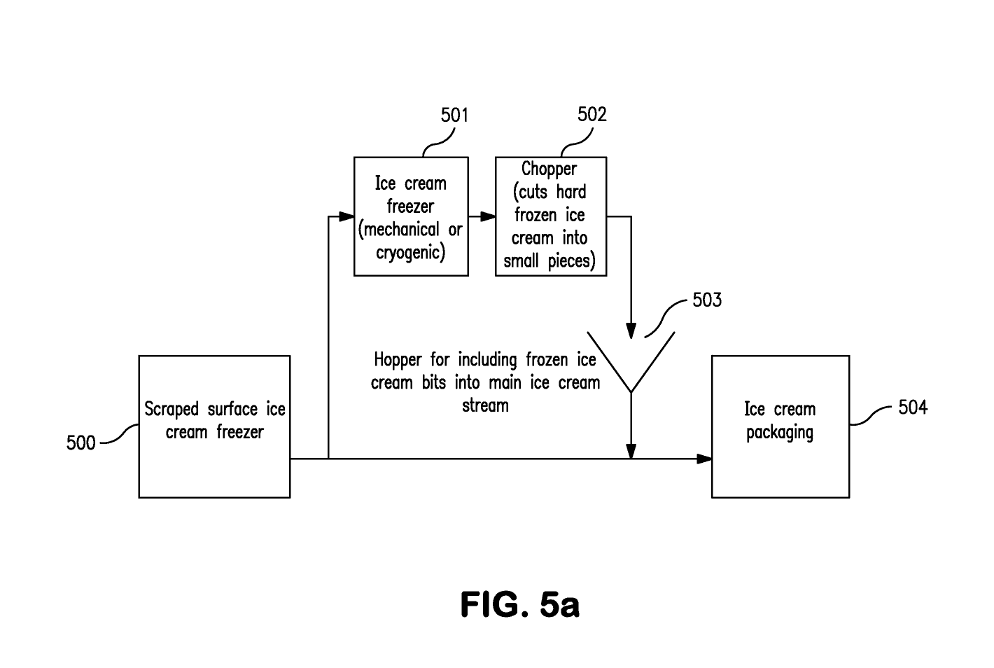

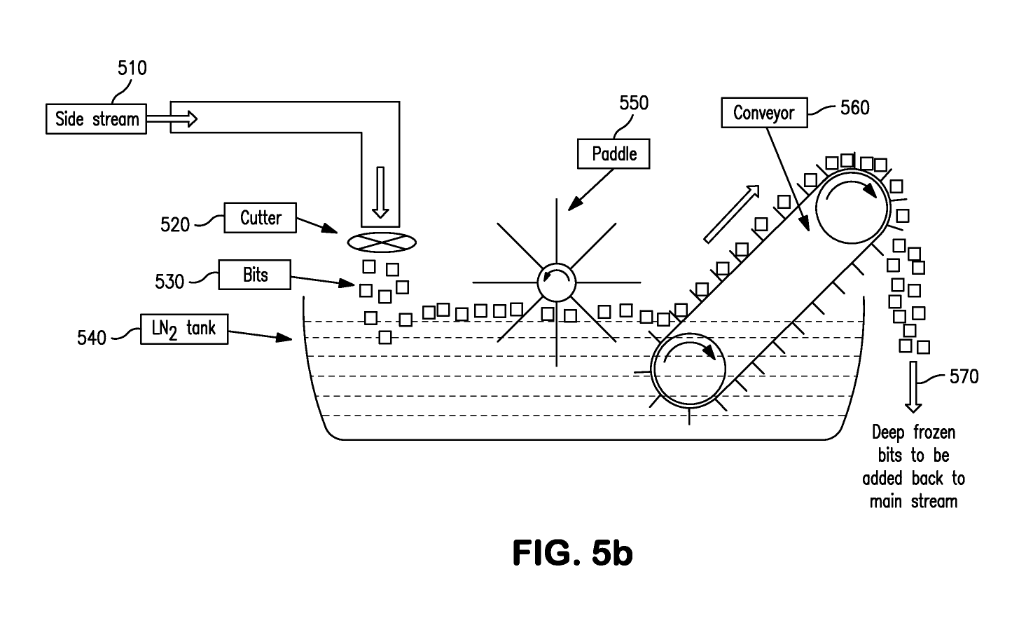

FIG. 5a depicts steps of the process for introducing super-cooled frozen bits into ice cream product for uniform chilling and/or freezing of the ice cream. From the product that is produced by a scraped surface ice cream freezer (500), a secondary stream is diverted and fed to a mechanical or cryogenic freezer (501). This product stream then passes from freezer (501) toward and into a chopper (502) which can be a rotating stainless steel drum cooled or even filled with liquid cryogen (normally liquid nitrogen). This chopper accomplishes cutting and producing a plurality of hard super-cooled frozen bits which fall into a hopper (503). The bits are then fed from hopper (503) into the main stream of the product, thereby providing more efficient and more rapid cooling of the main product stream, wherein the cooling is provided from within that stream. The resulting product can be subsequently packaged (504).

FIG. 5b is a schematic illustrating a device for creating the super-cooled bits. The side stream (510) is extruded through a cutting device (520) that portions the product into small bits (530), which subsequently fall into liquid nitrogen or equivalent cryogen in tank or vessel (540). The bits can enter tank or vessel (540) in other ways, such as on a conveyor belt, or by being physically carried. The bits spend a sufficient amount of time in the bath so that they can approach liquid nitrogen temperature. A slow moving paddle (550) or equivalent device preferably agitates the bits to ensure that the bits are sufficiently cooled. A device such as a conveyor with cleats (560) carries the bits out of the bath. The resulting super-cooled bits (570) should be at or below minus 50 degrees Fahrenheit, preferably below minus 100 degrees Fahrenheit, and more preferably at or below minus 200 or even minus 300 degrees Fahrenheit. In size, the bits are normally equal to or smaller than 1 inch and preferably equal to or smaller than 0.25 inches in equivalent diameter. The use of the phrase equivalent diameter is used here as the bits can be spherical or cylindrical or any other shape. The residence time of the hits in liquid nitrogen should be at least 5 seconds to ensure that they reach the desired temperature.

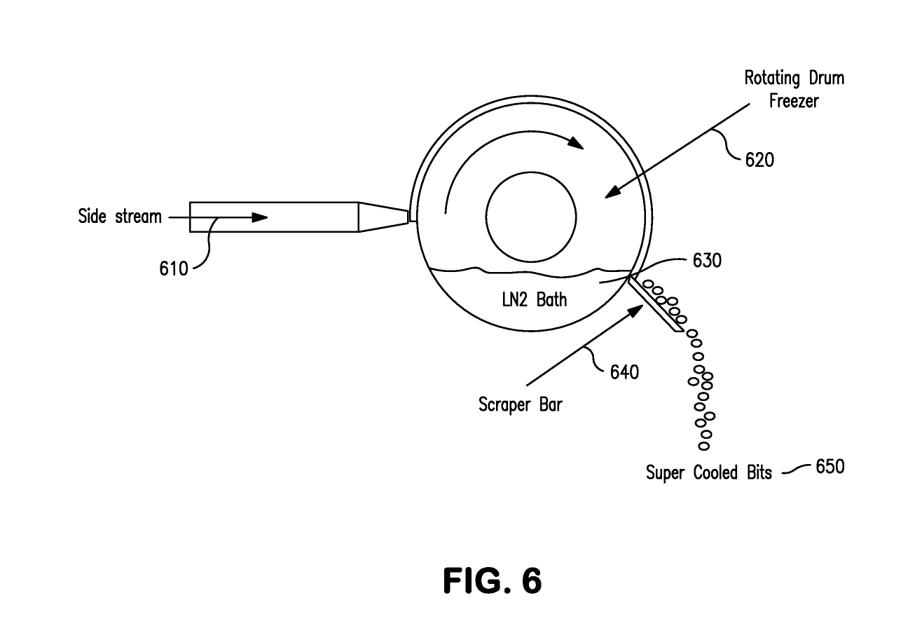

FIG. 6 is a schematic showing another method of creating the super-cooled bits. The side stream (610) is directed into contact with the outer surface of a rotating stainless steel drum (620) wherein the outer surface is cooled by liquid nitrogen (630) in the interior of drum (620). Alternatively, a moving or stationary flat metal (e.g. stainless steel) surface cooled from the underside by contact with e.g. liquid nitrogen can be used. The stream is extruded and a thin layer of the foam product contacts the super-cooled surface of the rotating drum or the flat metal surface, thereby freezing the product. After the foam layer has frozen to the required temperature, it is chipped off the rotating drum or flat metal surface using a scraper (640) to form a plurality of super-cooled bits (650). These bits are then mixed back into the main product stream as described herein.

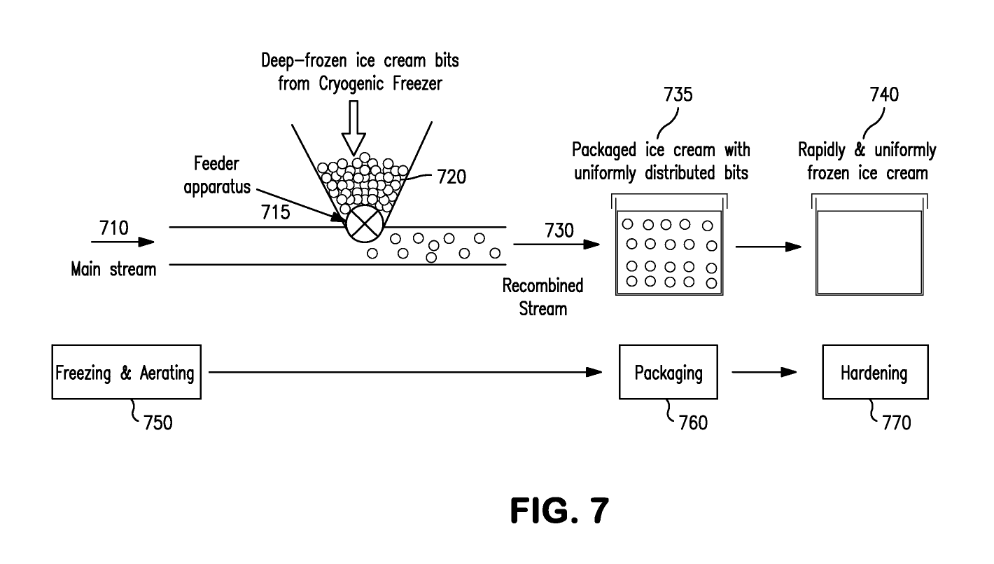

FIG. 7 is a schematic that shows a process for incorporating the super-cooled side stream bits into the main product stream. The super-cooled bits (720) are distributed into the main stream (710) using an ingredient feeder (715), also known as a fruit feeder, which is commonly used in the ice cream industry to incorporate inclusions like cookie bits, fruits, etc. into the ice cream. The uniformly distributed super-cooled bits in the packaged ice cream (735) act as internal refrigerants yielding rapidly and uniformly chilled and/or frozen product (740).

This unique approach of using super-cooled or frozen product bits recombined into the main product stream, and preferably into the interior of the product and throughout the product, provides an overall increase in heat transfer rate during processing due to the increase in available heat transfer surface area of the product stream being cooled by the frozen product bits. This unique advanced cooling technique involving the use of super-cooled or frozen pieces intermixed in large main stream process flows can be applied to various food products other than food foams, such as juices and other liquid or semi-solid food products.

Another method for chilling the product from within is to inject cryogenic gas or liquid into the interior of the mass of product through a plurality of thin conduits or hollow needles.

It should further be appreciated that cryogenic gas or liquid can advantageously be introduced into contact with the product, and/or into the interior of the product, in one or more of the stages described herein.

### Further Treatment Including Hardening

Following the viscosity increasing stage, the foam product is hardened by further chilling it. This chilling can be carried out using equipment that chills it from outside of the product, such as in a spiral or tunnel freezer. The targeted final temperature of the hardened product (such as in the case of ice cream) is about minus 20 degrees Fahrenheit. The hardening should achieve freezing of additional liquid present in the product. The further chilling in the hardening step should bring the temperature of the product to 0 degrees Fahrenheit or lower. The product can also be packaged, before or after or even during the hardening stage.

A technique that is useful in controlling the viscosity of the foam product or during the hardening stage, and improving the stability of the foam product, is to introduce a cryogen directly to the foam product as it is being pumped through piping or as it is being packaged. Direct chilling or freezing of the foam product impedes the diffusion of gas bubbles through and out of the foam product and also controls the ice crystal growth process that occurs during packaging and hardening. A preferred method to accomplish this alternate viscosity adjustment and ice crystal growth control is to deliver in-situ cryogenic chilling or freezing as the foam product is being packaged into its container. Yet another embodiment involves mostly indirect cooling of the outside of the piping through which the foam is being pumped. Other useful techniques include those described herein for carrying out the viscosity increasing step.

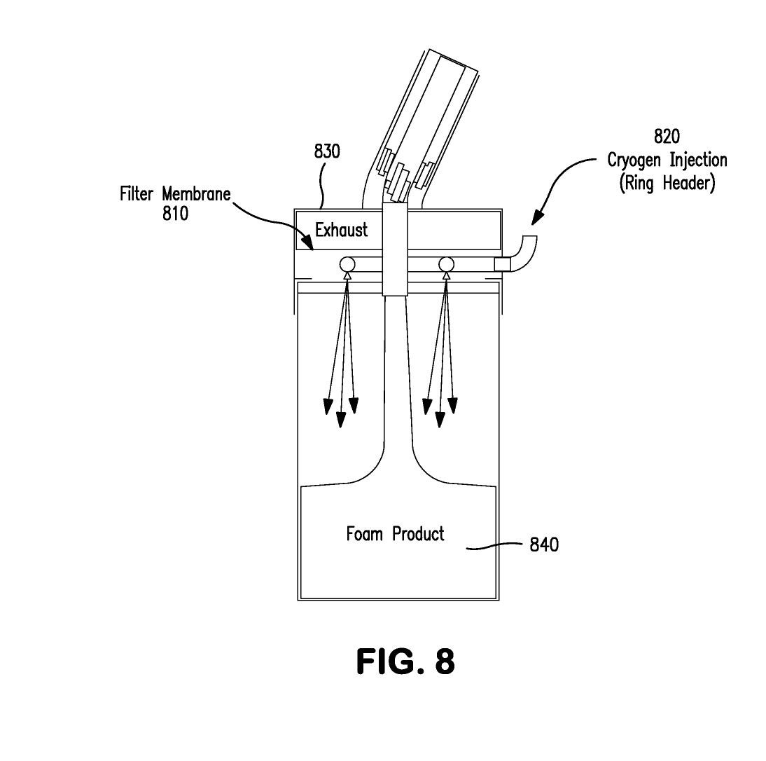

As shown in FIG. 8, as the foam product is loaded into the container, a cryogen such as liquid nitrogen is also introduced or injected into the container. During this in-situ cryogenic chilling during the packaging step, the liquid nitrogen is injected into the container from above using a ring header (820) with multiple injection points concurrently with dispensing the foam product (840) into the containers. The in-situ cryogenic chilling system also includes an exhaust system (830) including an exhaust manifold with a fitter membrane (810) to ensure that most of the nitrogen used is not retained in the foam product. Excess refrigeration capacity from the exhausted nitrogen can also be used to chill the foam product in transit before it reaches the container. This cryogenic chilling system further includes a ring header that is coupled to a source of liquid cryogen and the amount of cryogen that is injected is controlled via a controller (not shown) based on various input parameters that include product characteristics (gas, bubble size, product viscosity, product temperature, etc.) as well as other processing parameters such as container fill rate, and container fullness.

### Advantages of Small Bubble Size

Due to surface tension, the pressure inside a gas bubble is higher than ambient press The pressure inside the bubble is the sum of ambient pressure and the surface tension term;
(2σ/R), where
σ is the surface tension (which is expressed in units of force per distance, such as Newton per meter;
and R is the radius of the bubble.
   Therefore, the smaller the overall diameter of the bubble, the higher is the surface tension effect and therefore the pressure inside the bubble is also higher. This also means that smaller Nibbles are less sensitive to changes in ambient pressure.

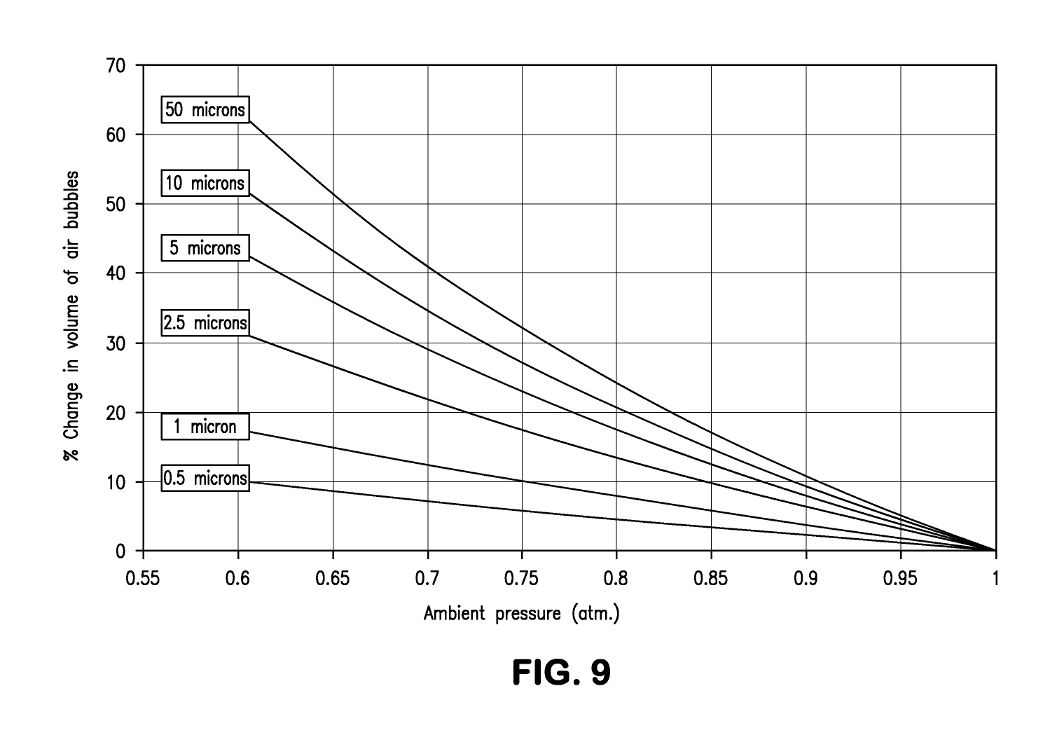

FIG. 9 is a plot that shows the theoretically obtained results of the effect of gas bubble size on the volume change in a foam product due to altitude changes. The ideal gas law was used to determine the effect of pressure on volume change of the gas bubble. The results show that smaller gas bubbles will experience less expansion due to changes in ambient pressure resulting from altitude changes, which is consistent with the equation described above. Thus, it is shown that the foam products with smaller gas bubbles are less susceptible to damage resulting from altitude changes.

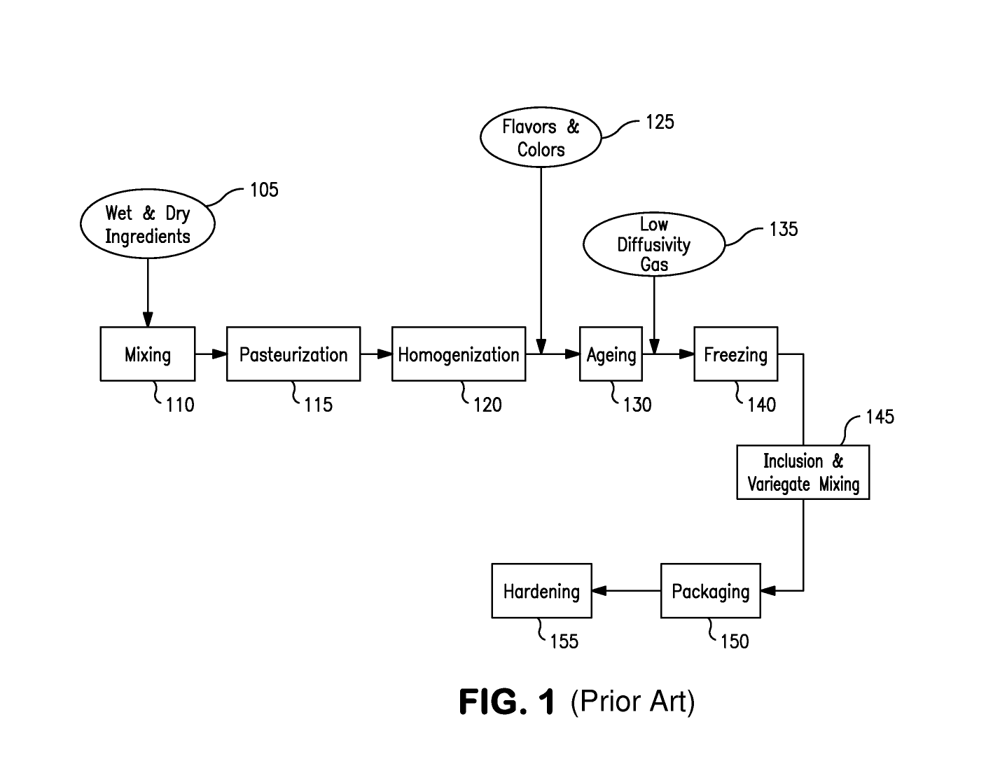

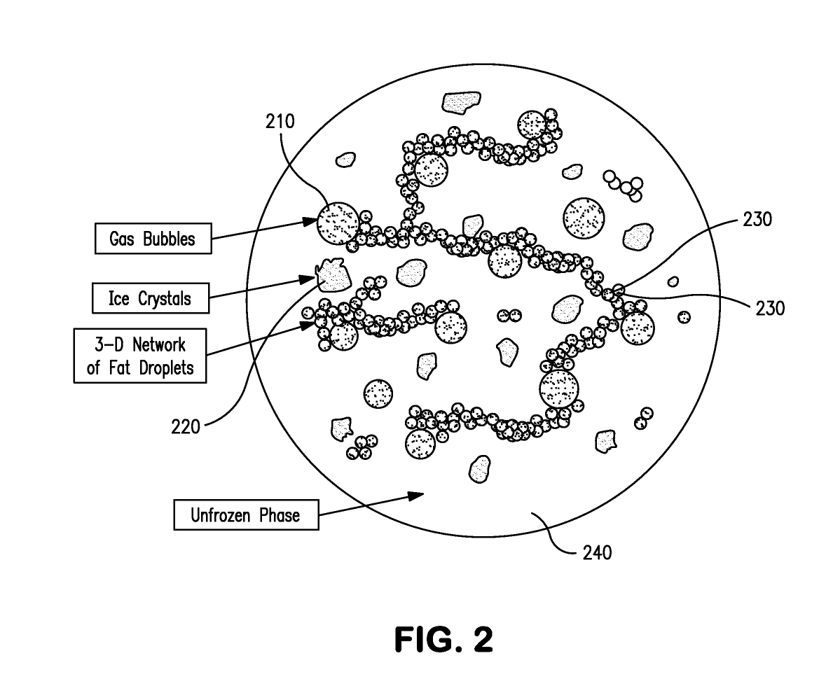

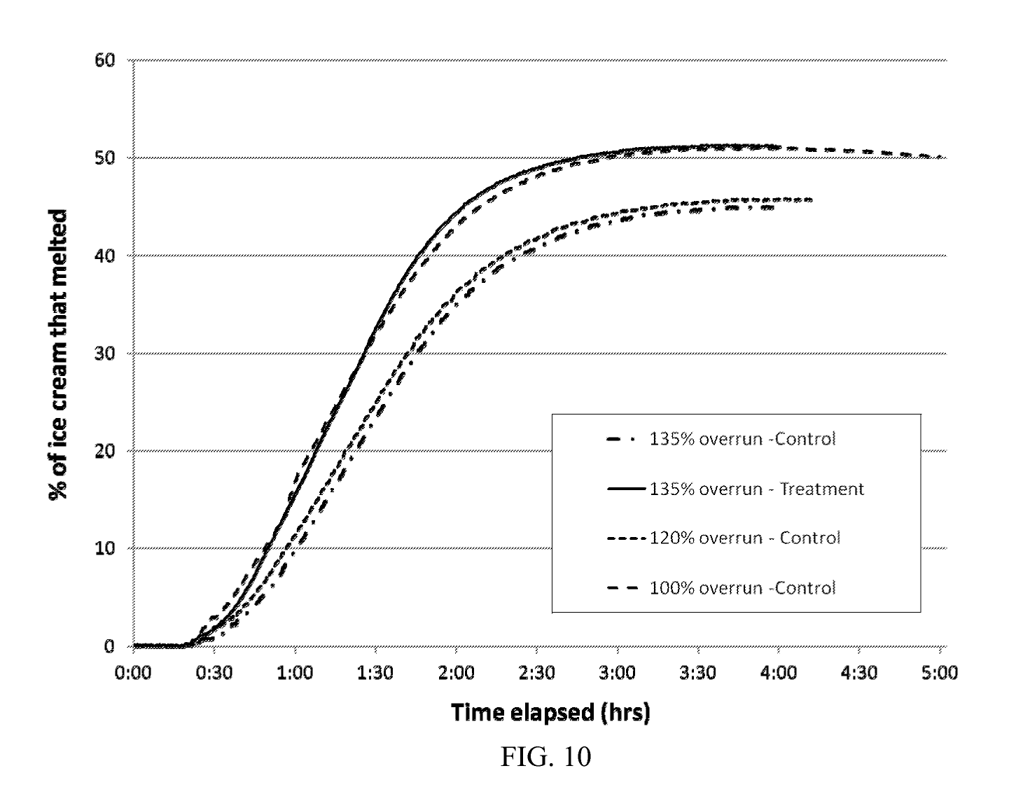

Melting tests are routinely used to determine the structure of frozen foam product. Several factors affect the melting profile of the product including; formulation, overrun, and microstructure. FIG. 10 provides the melting profiles for the various control and treatment ice creams. Specifically, FIG. 10 is a set of comparison curves of the melting profile for control ice cream, made using a prior art method (see FIG. 1), and treated ice cream, made according to the method of the present invention (FIGS. 3a and 3b). For the control ice creams, an increase in volume fraction of the gas phase (i.e. an increase in overrun) significantly changes the melting profile (as shown in FIG. 10). However, as seen, the treatments using the present invention shift the melting profiles of the high overrun foam products such that they now are more similar to the low overrun control ice creams. For e.g., the high overrun (135%) ice creams that have argon gas incorporated in them in place of air and have the viscosity increase step, the melting profile is the same as the control ice cream at a lower overrun (100%)

To further elucidate the issues described regarding the effect of bubble size in foam foods, Tables 1A and 1B provide the experimental results for the average bubble sizes and average ice crystal sizes, respectively, within the fully frozen product. These values were obtained when the treatments described herein were applied to 5 percent milk fat ice creams. The control ice cream was manufactured using known techniques as shown in FIG. 1. Treatment 1 denotes the use of argon gas instead of air and treatment 2 denotes the use of a cryogenic quick chilling and freezing step in addition to the use of argon gas in place of air (as also shown in FIGS. 3a and 3b). Other than the use of the tow diffusivity gas and the application of cryogenic quick chilling and freezing, all the other manufacturing parameters were the same as for the control ice cream manufacture. The numbers in brackets are the percentage reduction in average gas bubble sizes due to the treatments as compared to the control.

TABLE 1A
Average Gas Bubble Sizes (in Microns) Using Different Treatments
for for Ice Cream

| Overrun | Control | Treatment 1 | Treatment 2 |
|---|---|---|---|
| 100% | 22.8 | 16.4 | — |
| | | (28.1%) | — |
| 120% | 25.6 | 18.9 | — |
| | | (26.2%) | — |
| 135% | 27.9 | 22.7 | 17.4 |
| | | (18.6%) | (37.6%) |

TABLE 1B
Average Ice Crystal Sizes and Size Reductions (in Microns)
Using Different Treatments for Ice Cream

| Overrun | Control | Treatment 1 | Treatment 2 |
|---|---|---|---|
| 100% | 41 | 35 | — |
| | | (14.6%) | — |
| 120% | 38.9 | 37.5 | — |
| | | (3.6%) | |
| 135% | 40.9 | 34.9 | 27 |
| | | (14.7%) | (34%) |

The present invention provides a further frozen foam product in which the average bubble size is at least 15% smaller (preferably, 20% smaller, and even more preferably at least 25% smaller) than the average bubble size of a product formed from the identical starting material, with air as the sole gas or gas mixture fed to foam the product, and using identical treatment conditions but omitting the viscosity increase step described herein. Smaller gas bubbles significantly improve both taste and the aesthetic “creaminess” of ice cream and other foam products. Smaller gas bubbles have also been shown to contribute to the formation of smaller ice crystals both during the initial manufacturing of the frozen foam product as well as during subsequent transportation and storage.

Smaller gas bubbles also tend to provide a stronger microstructure within frozen foam products as well as improved melting properties and increased resistance to temperature and pressure fluctuations during storage and transportation. In essence, gas bubbles from a low diffusivity gas such as argon or krypton produce an average diameter reduction of size of at least 15 percent with a narrow bubble size distribution. This creates a stronger and more stable ice cream structure that does not melt as fast; is more tolerant to pressure fluctuations attributed to altitude issues and is much more resistant to temperature fluctuations. This improvement is particularly prevalent when the ice cream is held in long term storage in freezers. FIG. 9 provides a plot of the percent change in the volume of air bubbles as a function of ambient pressure and shows that at higher altitudes where the ambient pressure is lower, the volumetric expansion of the smaller gas bubbles is reduced. Equally important, a stronger microstructure of the ice cream product resulting from use of smaller gas bubbles in the ice cream products also allows use of less milk fats (i.e. a lower weight percentage of milk fats) without compromising the sensory aspects of the ice cream. Less milk fat yields reduced costs and improved dietary and nutritional aspects of the ice cream product.

Another advantage of smaller diameter gas bubbles within a (normally frozen) foam product is that the use of smaller gas bubbles leads to smaller fat droplets and improved fat dispersion which significantly improves taste and the sensory aspects of for example, ice cream products. In addition, smaller gas bubble diameters also tend to limit the growth of ice crystals during freezing, and subsequent hardening. The more numerous small gas bubbles trap the ice crystals within the foam product and thereby limit accretion or growth of the ice crystals.

However, the experience with prior production has been that smaller gas bubbles are expected to be more prone to disproportionation or diffusing gas molecules both within and outside of the foam product. This phenomenon is due to the higher internal pressure in the small bubbles. As gas bubbles diffuse within the product further increase in the coalescence of smaller bubbles into larger diameter bubbles occurs. During the hardening step, in many ice cream production processes, there is often a significant increase in average bubble size as a result of disproportionation resulting in poor air cell stability. As the ice cream product hardens, the viscosity of the product correspondingly increases and the average bubble size stabilizes. Reducing disproportionation of gas bubbles in an ice cream product significantly suppresses bubble size growth and improves the gas bubble stability in the ice cream product.

Use of lower diffusivity gases (as measured in water) such as argon, krypton, xenon etc. in combination with quickly increasing the viscosity of the foam products helps mitigate or stop the disproportionation of the gas bubbles in the foam. In particular, gases or gas mixtures containing argon, krypton, or xenon have been shown to resist diffusion out of a foam matrix in comparison with air, nitrogen, or other more traditional gases traditionally used in the production of foams.

Diffusivity or diffusion coefficient is determined using the following formula:

$${D}_{AB} = 0.00143 \frac{{T}^{1.75} \sqrt{( \frac{1}{{M}_{A}} + \frac{1}{{M}_{B}} )}}{{P [ {( \sum {V}_{A} )}^{1 / g} \vert {( \sum {V}_{B} )}^{1 / g} ]}^{2}}$$

in which,
D_{AB}=diffusivity of A in B or vice versa cm²/s)
T=temperature (degrees K)
M_{A} and M_{B} the molecular weights of components A and B respectively
P=pressure (atm)
ΣV_{A}, ΣV_{B} are the atomic diffusion volumes of molecules A and B respectively. These parameters are determined by adding the diffusion volumes of the various components that make up the molecule, which are found in published sources such as Table 11.1 in the book “The properties of gases and liquids” by Reid, R C; Prausnitz, J. M.; and Poling, B. E.; 4^{th} Edition, 1987, McGraw Hill Inc.
   Under conditions where the liquid is saturated with the gas, and temperature and pressure conditions are the same, the above equation reduces such that, the ratio of diffusivities of two different gases in the same liquid are given by the inverse ratios of the square roots of their molecular weights. Table 2 below provides data regarding the diffusivity of argon, krypton, and xenon in water compared to the diffusivity of nitrogen in water at conditions wherein the water is saturated with the gas.

TABLE 2
Gas Diffusivity in Water - Comparisons with Air

| | Diffusivity Ratio |
|---|---|
| | (i.e. diffusivity of the gas in water |
| | divided by diffusivity of nitrogen |
| Gas or Gas Mixture | in water) |
| Air | — |
| Nitrogen | 1.0 |
| Argon | 0.83 |
| Krypton | 0.59 |
| Xenon | 0.45 |

Alternate embodiments of the rapid cryogenic chilling aspect of the present system and method are shown in FIG. 3b in dashed lines. In particular, the secondary stream of product may be diverted to the cryogenic chiller or freezer prior to the step of gas mixing or immediately after the step of gas mixing. Still further embodiments include the diversion of pre-packaged stream, packaged stream, the hardened product stream or combinations of any of the above-identified diverted streams to the cryogenic chiller or freezer. Yet a further embodiment of the present system and method includes rapid cryogenic freezing or chilling of the inclusions (e.g. fruit, chocolate chips) or variegates (e.g. syrup) and incorporating the cryogenically chilled or frozen inclusions or variegates into the ice cream stream prior to or during the packaging step. In this manner, the viscosity of the recombined foam product prior to packaging and hardening is further increased. By adding the deep frozen product bits and uniformly dispersing the super-cooled or frozen product bits within the main stream, the recombined product stream is further chilled. This partial freezing of the recombined product stream rapidly increases the product viscosity during processing and significantly reduces gas bubble coalescence and disproportionation during the packaging and hardening of the foam product.

By using a combination of low diffusivity gas or gas mixtures producing relatively smaller bubble sizes, the altitude problems typically associated with ice cream products and other foam products are significantly reduced or even eliminated. For example, by using a low diffusivity gas such as argon and decreasing the average size of the gas bubbles in the foam to about 20 microns or less, preferably about 10 microns or less, together with a narrow bubble size distribution, the gas bubbles in ice cream are more resistant to the altitude problem. In short, this attitude problem is mitigated by the associated higher pressure inside the smaller gas bubbles reducing the impact of changes in ambient pressure.

Advantageously, the present system and method of enhancing the stability of foam products also allows increase in overrun, thus lowering the cost of production without any adverse effects on the quality of the foam product. Overrun, as previously described, is basically the ratio of the volume of gas in the foam to the volume of the non-gas portion of the foam. In fact, the present system and apparatus provides beneficial effects on the sensory characteristics of the foam products, such as ice cream. In particular, solely the use of small gas bubbles with low diffusivity gases yield the disclosed benefits of improved stability and enhanced sensory characteristics of the ice cream product or other food foam product. Likewise, the use of rapid cryogenic chilling of some or all of the ice cream or other foam product, alone, can also yield the disclosed benefits of improved stability and enhanced sensory characteristics. Together with increased overrun, there is a positive synergistic effect on the stability and sensory characteristics regarding the end foam product. Together with the combined use of low diffusivity gases, smaller gas bubbles, narrow gas bubble size distributions, and rapid cryogenic chilling, an improvement in both the process and the composition of the foam products occurs. More particularly, advancements in the control of the above-identified parameters as well as control of viscosity increase, rate of viscosity increase, via rate of bulk or average cooling (i.e. change in temperature as a function of time) as a result of the rapid cryogenic chilling or freezing are realized in the present system, methods and apparatus. Similarly, control of and improvement in the ice crystal formation as well as gas disproportionation rates and gas bubble size and bubble size distribution growth rates in hardened foam products are also realized.

The freezing and hardening steps can be the production limiting steps in many food foam manufacturing processes. The use of the quick chilling/hardening steps as described herein also have the added benefit of being able to overcome this production limitation, thus allowing manufacturers to increase their production capacity.

From the foregoing, it should be appreciated that the present invention thus provides a method and system for the improved stability and sensory characteristics of frozen foam products. While the invention herein disclosed has been described by means of specific embodiments and processes or control techniques associated therewith, numerous modifications and variations can be made thereto by those skilled in the art without departing from the scope of the invention as set forth in the claims or sacrificing all of its features and advantages.

Various modifications and changes may be made with respect to the foregoing detailed description and certain embodiments of the invention will become apparent to those skilled in the art without departing from the spirit of the present disclosure.

What is claimed is:

1. A method for forming a frozen foamed food product comprising the steps of:
(A) introducing a selected gas or gas mixture which is air or is a gas or gas mixture which possesses a larger average molecular weight than air, into a product to be foamed under selected foaming conditions to form a foam product containing bubbles of said gas or gas mixture,
(B) in a selected relationship of being concurrent with or subsequent to step (A), chilling said foam product under selected chilling conditions to form a partially frozen foam product; and then
(C) increasing the viscosity of said partially frozen foam product by rapidly chilling it, thereby forming a further frozen foam product, and then
(D) hardening the further frozen food product by further chilling it under selected further chilling conditions to freeze additional liquid therein, so that the temperature of the product is 0 degrees Fahrenheit or lower, thereby forming a frozen foamed food product,
under conditions effective to establish bubbles in said frozen foamed food product having an average bubble size at least 15% smaller than the average bubble size in the hardened product that is formed by introducing solely air as the gas or gas mixture into the identical product to be foamed under the identical selected foaming conditions as in step (A) to form an air foamed product and chilling said air foamed product in the same selected relationship to step (A) and under the identical selected chilling conditions as in step (B) to form a product which is then hardened under the identical selected further chilling conditions as in step (D).

2. The method of claim 1 wherein in step (C) said partially frozen foam product is chilled at a rate such that at least 5 wt. % of the amount of liquid present in said partially frozen foam product at the beginning of step (B) is frozen to solid in 5 minutes or less.

3. The method of claim 1, wherein the step of increasing the viscosity of said partially frozen foam product in step (C) comprises chilling the partially frozen foam product from within.

4. The method of claim 1, wherein the step of increasing the viscosity of said partially frozen foam product in step (C) comprises:
forming a portion of a partially frozen foam product, that is produced by (i) introducing a gas or gas mixture into a product to be foamed in a manner which forms bubbles in said product, thereby forming a foam product, and (ii) concurrently with or subsequent to step (i), chilling said foam product while retaining said bubbles therein, to form said partially frozen foam product, into a plurality of bits, wherein said bits have a temperature lower than minus 50 degrees Fahrenheit and lower than the temperature of said partially frozen foam product; and
adding said bits to said partially frozen foam product in step (C).

5. The method of claim 1, wherein the step of increasing the viscosity of said partially frozen foam product in step (C) comprises:
producing a partially frozen foam product by (i) introducing a gas or gas mixture into a product to be foamed to form bubbles therein, thereby forming a foam product, and (ii) concurrently with or subsequent to step (i), chilling said foam product while retaining said bubbles therein, to form said partially frozen foam product;
rapidly chilling or freezing a portion of said partially frozen foam product; and
adding said rapidly chilled or frozen portion to said partially frozen foam product in step (C).

6. The method of claim 1, wherein said gas or gas mixture possesses a larger average molecular weight than air.

7. The method of claim 1 wherein said gas or gas mixture comprises one or more of argon, krypton, or xenon.

8. The method of claim 1, wherein said frozen foam product is ice cream.

9. A method according to claim 1 wherein a gas or gas mixture or liquefied gas is introduced in one or more of steps (A), (B), (C) or (D) into said product and the temperature of said introduced gas, gas mixture or liquefied gas is lower than the temperature of said product into which the gas, gas mixture or liquefied gas is introduced, and said introduced gas, gas mixture or liquefied gas chills said product.

10. A method for forming a frozen foamed food product comprising the steps of:
(A) introducing a selected gas or gas mixture which is air or is a gas or gas mixture which possesses a larger average molecular weight than air, into a product to be foamed under selected foaming conditions to form a foam product containing bubbles of said gas or gas mixture, and then
(B) increasing the viscosity of said foam product by rapidly chilling it, thereby forming a further frozen foam product, and then
(C) hardening the further frozen food product by further chilling it under selected further chilling conditions to freeze additional liquid therein, so that the temperature of the product is 0 degrees Fahrenheit or lower, thereby forming a frozen foamed food product,
under conditions effective to establish bubbles in said frozen foamed food product having an average bubble size at least 15% smaller than the average bubble size in the hardened product that is formed by introducing solely air as the gas or gas mixture into the identical product to be foamed under the identical selected foaming conditions as in step (A) to form an air foamed product which is then hardened under the identical selected further chilling conditions as in step (C).

11. The method of claim 10 wherein in step (B) said foam product is chilled at a rate such that at least 5 wt. % of the amount of liquid present in said partially frozen foam product at the beginning of step (B) is frozen to solid in 5 minutes or less.

12. The method of claim 10 wherein the step of increasing the viscosity of said partially frozen foam product in step (B) comprises chilling the foam product from within.

13. The method of claim 10 wherein the step of increasing the viscosity of said foam product in step (B) comprises:
forming a portion of a foam product, that is produced by (i) introducing a gas or gas mixture into a product to be foamed in a manner which forms bubbles in said product, thereby forming a foam product, and (ii) concurrently with or subsequent to step (i), chilling said foam product while retaining said bubbles therein, to form said foam product, into a plurality of bits wherein said bits have a temperature lower than minus 50 degrees Fahrenheit and lower than the temperature of said foam product; and
adding said bits to said foam product in step (B).

14. The method of claim 10 wherein the step of increasing the viscosity of said foam product in step (B) comprises:
producing a foam product by (i) introducing a gas or gas mixture into a product to be foamed in a manner which produces bubbles in said foam product, thereby forming a foam product, and (ii) concurrently with or subsequent to step (i), chilling said foam product while retaining said bubbles therein;
chilling or freezing a portion of said foam product, to form a partially chilled or frozen foam product; and adding said chilled or frozen portion to said foam product in step (B).

15. The method of claim 10, wherein said gas or gas mixture possesses a larger average molecular weight than air.

16. The method of claim 10 wherein said gas or gas mixture comprises one or more of argon, krypton, or xenon.

17. A method according to claim 10 wherein a gas or gas mixture or liquefied gas is introduced in one or more of steps (A), (B) and (C) into said product and the temperature of said introduced gas, gas mixture or liquefied gas is lower than the temperature of said product into which the gas, gas mixture or liquefied gas is introduced, and said introduced gas, gas mixture or liquefied gas chills said product.

18. A frozen foamed food product made by a method according to claim 1.

19. A frozen foamed food product made by a method according to claim 10.

20. A system comprising
(A) a source of a product to be foamed, which product contains liquid;
(B) a source of air or of a gas or gas mixture which possesses a larger average molecular weight than air;
(C) foaming apparatus, connected to said source of a product to be foamed and connected to said source of said gas or gas mixture, which is capable of introducing said gas or gas mixture into said product to be foamed, in a manner which forms bubbles of said gas or gas mixture in said product, thereby forming a foam product;
(D) second apparatus, connected to said foaming apparatus to receive therefrom said foam product, which is capable of chilling or partially freezing said foam product while retaining said babbles therein, to form a partially frozen foam product; and
(E) viscosity increasing apparatus, connected to said second apparatus to receive therefrom said partially frozen foam product, which is capable of increasing the viscosity of said partially frozen foam product by rapidly chilling it.

21. A system according to claim 20 wherein the viscosity increasing apparatus includes apparatus capable of chilling said product from within.

22. A system according to claim 20 wherein the viscosity increasing apparatus includes a bit-forming apparatus capable of forming bits having the composition of said foam product and having a temperature less than minus 50 degrees Fahrenheit, wherein said bit-forming apparatus is connected to said viscosity increasing apparatus to feed said bits into said partially frozen foam product in said viscosity increasing apparatus.

23. A system according to claim 22 wherein said bit-forming apparatus comprises an extruder, connected to apparatus capable of producing partially frozen foam product containing bubbles therein to receive partially frozen foam product from the apparatus, wherein said extruder also has an exit section,
a cutting device connected to said exit section of said extruder capable of cutting product extruded from said exit section into bits,
a vessel located proximate said exit section to receive in said vessel bits cut by said cutting device,
a source of cryogen coupled to said vessel to controllably feed cryogen into said vessel, and
apparatus capable of removing bits out of said vessel and feeding them into said partially frozen foam product in said viscosity increasing apparatus.

24. A system comprising
(A) a source of a product to be foamed, which product contains liquid;
(B) a source of air or of a gas or gas mixture which possesses a larger average molecular size than air;
(C) foaming apparatus, connected to said source of a product to be foamed and connected to said source of said gas or gas mixture, which is capable of introducing said gas or gas mixture into said product to be foamed, in a manner which forms bubbles of said gas or gas mixture in said product, thereby forming a foam product; and
(D) viscosity increasing apparatus, connected to said foaming apparatus to receive therefrom said foam product, which is capable of increasing the viscosity of said foam product by rapidly chilling it.

25. A system according to claim 24 wherein said viscosity increasing apparatus includes apparatus capable of chilling said product from within.

26. A system according to claim 24 wherein the viscosity increasing apparatus includes bit-forming apparatus capable of forming bits having the composition of said foam product and having a temperature less than minus 50 degrees Fahrenheit, wherein the bit-forming apparatus is connected to the viscosity increasing apparatus to feed said bits into said partially frozen foam product in said viscosity increasing apparatus.

27. A system according to claim 26 wherein said bit-forming apparatus comprises
an extruder, connected to apparatus capable of producing foam product containing bubbles therein to receive said foam product from said apparatus, wherein said extruder also has an exit section,
a cutting device connected to said exit section of said extruder capable of cutting product extruded from said exit section into bits,
a vessel located proximate said exit section to receive in said vessel bits cut by said cutting device,
a source of cryogen coupled to said vessel to controllably feed cryogen into said vessel, and
apparatus capable of removing bits out of said vessel and feeding them into said foam product in said viscosity increasing apparatus.

28. An apparatus useful for creating super-cooled bits comprising
an extruder with an exit section,
a cutting device connected to said exit section of said extruder for cutting product extruded from said exit section into bits,
a vessel located proximate said exit section to receive bits cut by said cutting device in said vessel,
a source of liquid cryogen coupled to said vessel to controllably feed said liquid cryogen into said vessel, and a conveyor capable of carrying bits out of liquid cryogen in said vessel.

29. A method of forming super-cooled bits, comprising providing a bath of liquid cryogen in the vessel of an apparatus according to claim 28, extruding material from the exit section of an extruder in said apparatus, cutting said extruded material into bits with said cutting device, contacting said bits with liquid cryogen in said vessel, permitting said bits to remain in liquid cryogen in said vessel until they are cooled to a temperature of minus 50 degrees Fahrenheit or colder, and removing said cooled bits from said liquid cryogen.
